(19) United States
(12) Patent Application Publication
(10) Pub. No.: US 2026/0092620 A1
(43) Pub. Date: Apr. 2, 2026

(54) FASTENER CAP

(71) Applicant: Kwik Lok Corporation, Union Gap, WA (US)

(72) Inventors: Bruce GOODELL, Yakima, WA (US); Miguel OCHOA, Yakima, WA (US); Keith KUBISHTA, Yakima, WA (US); Ryan TOWRY, Naches, WA (US)

(21) Appl. No.: 19/345,920

(22) Filed: Sep. 30, 2025

Related U.S. Application Data
(60) Provisional application No. 63/702,042, filed on Oct. 1, 2024.

(51) Int. Cl. F16B 15/08

(52) U.S. Cl. CPC F16B 15/08

(57) ABSTRACT

A fastener cap includes a body having a top edge, a bottom edge, and side edges. The body has a thickness between 0.01 inches and 0.05 inches and protrusions extending from the body. Webs extend from the protrusions with each web extending from a corresponding one of the plurality of protrusions by a distance between 0.003 and 0.009 inches and each of the webs having a width between 0.008 and 0.014 inches. The fastener caps are coupled together by the webs in a continuous strip or roll. A roll of fastener caps includes a core-less design with a central opening bounded by three of the fastener caps in the roll. The reduced thickness of each cap and the core-less design increase the number of caps per roll. A method of manufacturing the caps allows for continuous production of a single and integral strip of interconnected caps.

### BACKGROUND

### Technical Field

The present disclosure is generally directed to fastener caps for securing underlayment to a substrate.

### Description of the Related Art

Fastener caps are employed in the construction industry to secure underlayment such as protective plastic sheeting, wraps, asphalt, metallic roof panels, or other moisture barriers to a wood substrate. For example, fastener caps are commonly used to attach roof and house wrap underlayment to the plywood framing substrate through an applicator such as a cap nailer, fastener driving tool, or nail gun. When a cap nailer is used, the fastener caps are fed through the cap nailer as a separate roll from the fasteners and the cap nailer applies a fastener through the fastener cap during installation to secure the fastener cap over the underlayment.

Conventional fastener caps are manufactured by injection molding each individual cap and then welding the caps into a roll, which increases costs. Further, the rolls of caps that are provided to the applicator have a limited number of caps per roll such that a user must frequently stop work to replace a depleted roll with a new roll. Known fastener caps are also manufactured with plastic that may not be recycleable and/or compostable. Accordingly, it would be advantageous to have a fastener cap that overcomes these and other deficiencies and disadvantages of current solutions.

### BRIEF SUMMARY

The present disclosure is generally directed to fastener caps that may be applied or secured to a substrate to attach underlayment or other types of wraps to the substrate. The caps have a reduced thickness relative to conventional designs as well as a core-less configuration when rolled to increase the number of caps per roll relative to conventional solutions. For example, the concepts of the disclosure enable rolls that include 400 caps in the same 5.25 outer diameter roll as conventional solutions. Larger rolls with more caps are also contemplated. The caps have protrusions that terminate in webs that are interconnected or collated with other webs of adjoining caps in the strip or roll configuration. The webs are broken by an applicator during installation. Further, the caps are formed into strips (which are subsequently rolled) through an extrusion and die cut process that produces a single, continuous, and integral strip of interconnected caps. The manufacturing process allows for production of thinner caps with lower likelihood of manufacturing defects relative to conventional molding techniques and is also much more efficient than manufacturing each cap individually and welding the caps together. The caps may be formed of a selected material, but may preferably be a bioplastic material that is recyclable and/or compostable, or the caps may be manufactured from a recycled material. Additional features, benefits, and advantages of the concepts of the disclosure are described below with reference to the accompanying figures.

### BRIEF DESCRIPTION OF THE SEVERAL VIEWS OF THE DRAWINGS

The present disclosure will be more fully understood by reference to the following figures, which are for illustrative purposes only. The non-limiting and non-exhaustive implementations of the disclosure are described with reference to the following figures, wherein like labels refer to like parts throughout the various views unless otherwise specified. The figures do not describe every aspect of the teachings disclosed herein and do not limit the scope of the claims.

FIGS. 1A and 1B are views of a conventional fastener cap roll and fastener cap assembly, respectively.

FIG. 2A is a plan view of an implementation of a fastener cap according to the present disclosure.

FIG. 2B is a plan view of the fastener cap of FIG. 2A joined to other fastener caps in a strip.

FIG. 2C is an isometric view of the fastener cap of FIG. 2A joined to other fastener caps in a roll.

FIG. 2D is a schematic view of a core of the roll of FIG. 2C.

FIGS. 3A-3C are schematic views illustrating steps in a manufacturing process of a fastener cap, strip of fastener caps, or roll of fastener caps according to the present disclosure.

FIG. 4 is a plan view of an implementation of a strip of fastener caps according to the present disclosure.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide fastener cap devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

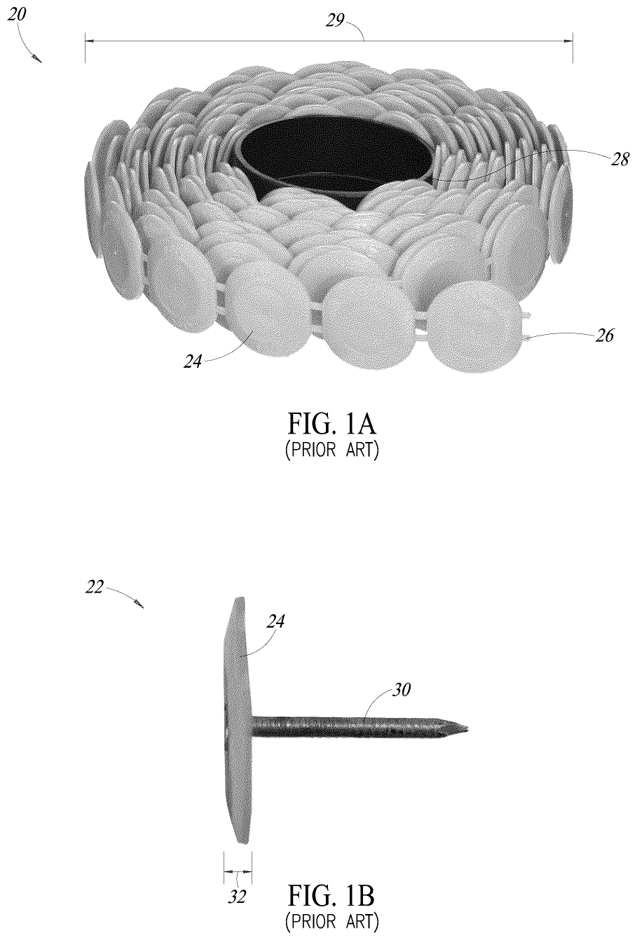

FIGS. 1A and 1B are views of a conventional fastener cap roll 20 and fastener cap assembly 22, respectively, provided to illustrate the disadvantages of known solutions and emphasize the benefits and advantages of the present disclosure. Beginning with FIG. 1A, a conventional fastener cap roll 20 includes fastener caps 24 that are coupled to each other via extensions 26. The caps 24 are arranged and rolled around a core 28. The core 28 may be a hollow tube of plastic with a diameter of 2 inches that assists with rolling and securing the caps 24 in the rolled configuration. The roller may also have an outer diameter 29 of 5.25 inches that corresponds to a diameter of a container on the applicator that receives the roll 20. In some implementations, the core 28 also engages a corresponding part of an applicator to center the roll in the applicator and assist with feeding the caps 24 through the applicator.

Turning to FIG. 1B, with continuing reference to FIG. 1A, the fastener cap assembly includes the fastener cap 24 and a nail 30. As noted above, the fastener cap roll 20 and the nails 30 may be provided separately to an applicator. The applicator applies the caps 24 to a substrate (not shown) by inserting a nail 30 through the caps 24 to break a single cap 24 from the roll 20 and secure the fastener assembly 22 to the substrate. Where the applicator is a cap nailer or a nail or staple gun, the applicator may use pneumatic pressure to drive the nail 30 through the cap 24 and into the substrate. Other fasteners besides nails 30 may be used, such as staples. The fastener cap assembly 22 can also be driven into the substrate manually. The caps 24 have a thickness 32 of ⅛″ (0.125 inches) or more in some examples. The cap assembly 22 may include caps 24 that intentionally have a thickness 32 that prevents the fastener head or crown from pulling through the cap 24 while effectively sealing around the fastener body to prevent moisture intrusion through the fastener holes.

Each of the rolls 20 may include 200 collated caps 24. Because of limitations regarding the core 28, the thickness 32 of the caps, and the size of the chamber on the applicator that holds the roll 20, the maximum number of caps 24 cannot be increased using the aforementioned design and configuration of the rolls 20. Each roll 20 of 200 caps 24 and associated roll of nails 30 may be sufficient to secure 25 square feet of underlayment to the substrate assuming industry standard installation practices are followed. The average home in America has a roof that is approximately 1,700 square feet, meaning that a user must stop work to change rolls 20 at least 68 times during an average roofing job, which is a significant loss of time and associated increase in cost to consumers. When the rolls 20 are used for installing house wrap or siding underlayment instead, the square footage may be greater than the roof depending on the configuration of the house. Thus, even more work stoppages are needed to change rolls 20.

Conventional caps 24 are manufactured by injection molding and welding the individual caps 24 together at the extensions 26 to form the rolls 20. This process is slow and cost intensive, which increases the overall cost of each roll 20 for consumers. In addition, forming the caps 24 as individual pieces and subsequently welding the pieces together can lead to quality control issues and manufacturing defects where the extensions 26 are not properly welded. Improper welds can cause the rolls 20 and/or caps 24 to break before installation, forcing a user to reload the caps 24. Improper welds can also jam the applicator, thus requiring further work stoppages to correct the issue and posing a possible safety concern to users. Injection molding also benefits from higher wall thicknesses of the injection molded parts because thinner parts are more likely to have manufacturing defects due to the molding process. Thus, reducing the thickness 32 of the caps 24 through conventional injection molding techniques is unlikely to result in a desirable solution.

The present disclosure is generally directed to fastener caps that overcome the above and other deficiencies and disadvantages of known solutions. For example, the caps of the present disclosure may be manufactured from recyclable materials and/or compostable material while also retaining sufficient durability and rigidity to prevent the fasteners from pulling through the caps even when exposed to harsh outdoor conditions such as rain, snow, sleet, ice, and prolonged UV exposure from sunlight. The caps may also be manufactured from recycled materials. The caps discussed herein are also rolled in a core-less design and manufactured with a reduced thickness per cap that enables each roll to contain 400 or more caps in the same size roll, namely a 5.25-inch outer diameter roll, that is used for known solutions. This allows each roll of caps according to the disclosure to cover twice as much area (i.e., at least 50 square feet) before a replacement is needed while still enabling the rolls to be used with standard applicators. The increase in caps per roll results in a significant time and cost savings to users and consumers. The caps are also manufactured in a continuous process to produce a continuous strip of interconnected caps, which allows for a reduction in thickness of the caps and increases in manufacturing efficiency while also reducing the likelihood of manufacturing defects. The manufacturing process also enables production of larger rolls of caps, if desired, and the continuous process reduces the potential for manufacturing defects. These and other features, benefits, and advantages of the concepts of the disclosure will be described further below.

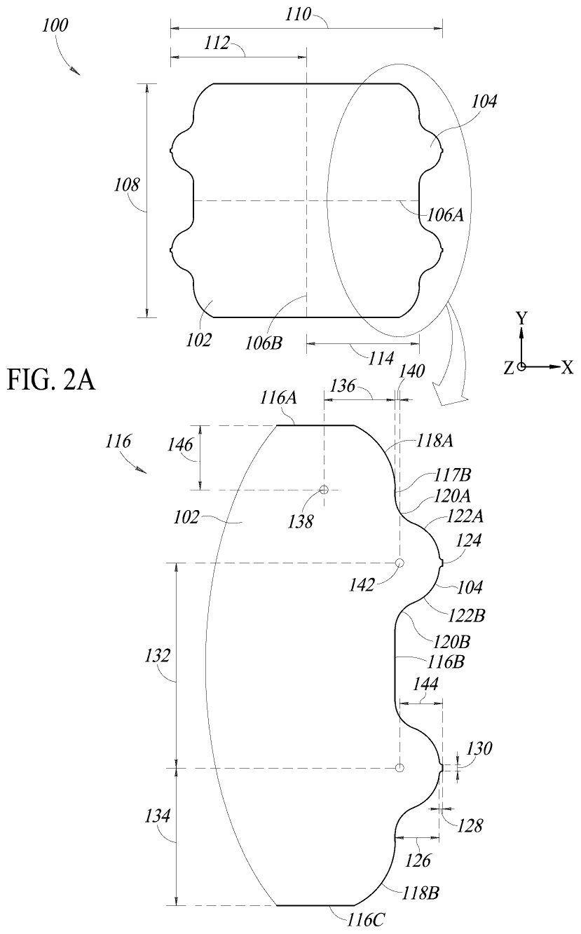

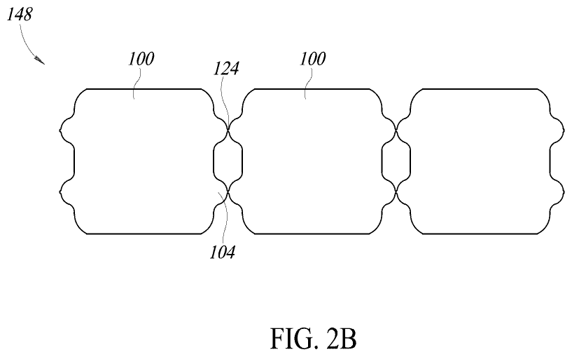

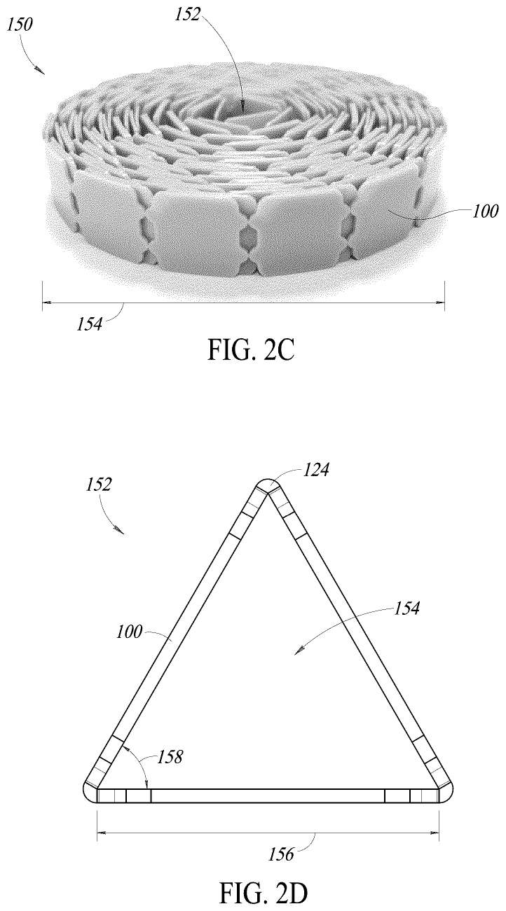

FIG. 2A is a plan view of an implementation of a fastener cap 100 according to the present disclosure. The fastener cap 100 includes a body 102 (or substrate 102) that may be flat and planar on opposing major surfaces (i.e., surfaces of the body 102 with the greatest surface area). The major surfaces of the body may also include knurling or other surface texture as a result of the manufacturing process described herein or as an intentional feature to improve grip of the applicator on the body 102 or to provide other advantages. The fastener caps 100 are a selected material, which can include, but is not limited to plastic and/or compostable materials and/or recycled materials. Non-plastic and non-compostable materials are also considered. Preferably, the selected plastic material is either previously recycled material that is issued again for the caps 100 and/or a material that is recyclable through currently available commercial or municipal recycling plants although the same is not required.

The body 102 includes a selected number of protrusions 104 that assist with facilitating interconnection of the caps 100 while also providing additional structural support and rigidity to the body 102 of the caps 100. In the illustrated implementation, there are four protrusions 104 that each have a shape and dimensions described further herein. One protrusion 104 may be positioned in each of four quadrants of the body 102 where the quadrants are defined by a horizontal center line 106A and a vertical center line 106B through the body 102. Each of the protrusions 104 extend from the body 102 and are formed integrally with a body 102 as a single, unitary, continuous piece. The protrusions 104 therefore assist with defining, in combination with the body 102, an outer edge of each cap 100. Further, because one protrusion 104 is positioned in each quadrant of the body 102, there are preferably two protrusions 104 positioned on a left side of the body 102 and two protrusions on a right side of the body 102. Each protrusion 104 on one side (i.e., the left side) may be aligned with each corresponding protrusion 104 on the opposite side (i.e., the right side). Or, in other words, the protrusion 104 in the upper left quadrant may be aligned across the body 102 with the corresponding protrusion 104 in the upper right quadrant of the body 102. Other configurations of the protrusions 104 are contemplated, including at least the protrusions 104 being offset relative to each other or positioned at selected locations along sides of the body 102.

The fastener cap 100 has a width 108 in a y-axis direction between outermost points or edges in the y-axis direction that may be 0.844 inches and a pitch 110 in an x-axis direction between outermost points or edges in the x-axis direction that may be 0.984 inches. Accordingly, a pitch 112 from an outermost point of one side (i.e., a left side) of the cap 100 to the vertical centerline 106B may be half of the pitch 110 or 0.492 inches. A distance 114 from the vertical centerline 106B to an outer point or edge of the body 102 where the body 102 interfaces with the protrusions 104 may be 0.408 inches. The fastener cap 100 may have a thickness in a z-axis direction between the opposing flat and planar surfaces of 0.035 inches, which assists with enabling more caps 100 to be included in each roll with the same outer diameter as conventional fastener cap rolls 20. This significantly reduced thickness relative to conventional fastener caps 24 is enabled by the difference in manufacturing method relative to conventional methods, as further explained below.

FIG. 2A also includes a detail view of area A showing additional detail of a portion of a right side of the fastener cap 100 to provide more information regarding the details of the protrusions 104 and the fastener cap 100 generally. The fastener cap 100 may have an outermost edge or boundary 116 that includes horizontal and vertical rectilinear sections between the protrusions, except as otherwise provided below, to give the fastener caps 100 a modified square or modified rectangular shape. A top boundary line 116A of the fastener cap 104, which may be a horizontal straight line, curves toward the upper right protrusion 104 with a first convex curve 118A that may have a radius of curvature of 0.125 inches. The first convex curve 118A is between the horizontal top boundary line and a first vertical section 117 of the right vertical boundary line 116B. The first vertical section 117 transitions into a first concave curve 120A that may have a radius of curvature of 0.050 inches. The first concave curve 120A transitions to the upper right protrusion 104 at a first inflection point 122A. Each protrusion 104 may be rounded and have a radius of curvature of 0.070 inches. Further, each protrusion 104 includes a web 124 extending from a center of the protrusion 104 that may be a rectangular extension. The webs 124 of the protrusions 104 facilitate the connection between caps 100, as further described herein.

In an implementation, each protrusion 104 has a radius of curvature of 0.070 inches on each opposite side of the web 124 positioned at a center of the rounded protrusion 104. Thus, each protrusion 104 rounds convexly toward the web 124, which includes rectilinear edges, before rounding convexly away from the web 124 with a similar curvature. Thus, below the web 124 of the upper right protrusion 104, there is a curve with a radius of curvature that may be 0.070 inches followed by a second inflection point 122B where the protrusion 104 transitions to a second concave curve 120B with a radius of curvature of 0.050 inches. The second concave curve 120B meets the right vertical boundary line 116B. The above pattern repeats in relevant part for the lower right protrusion 104. Then, there is a second convex curve 118B between the right vertical boundary line 116B below the lower right protrusion 104 and a bottom horizontal boundary line 116C.

The protrusions 104 may extend from the body 102 by a distance 126 of 0.084 inches and the webs 124 may extend from the rounded surface of the protrusions 104 by a distance 128 of 0.006 inches in the x-axis direction. The webs 124 may have a width 130 in the y-axis direction of 0.011 inches. A distance 132 between a horizontal centerline through each of the webs 124 may 0.360 inches. Further, a horizontal centerline through the webs 124 may be spaced from the top or bottom horizontal boundary lines 116A, 116B by a distance 134 of 0.242 inches. A distance 136 between a reference point 138 for measurement of the radius of curvature of the first convex curve 118A and the first vertical section 117 may be 0.125 inches. A distance 140 between the first vertical section 117 and a reference point 142 for the measurement of the radius of curvature of the protrusions 104 may be 0.008 inches. A distance 144 between the reference point 142 and an outermost point of the protrusions 104 excluding the webs 124 may be 0.078 inches. A distance 146 between the top horizontal boundary line 116A an the reference point 138 may be 0.113 inches.

While the above dimensions and curvatures are provided for one side (i.e., a right side) of one fastener cap 100, it is be appreciated that the opposite side (i.e., a left side) may have the same dimensions and configuration, and that each fastener cap 100 may have the same dimensions and configuration as the other fastener caps subject to manufacturing tolerances recited herein. Each of the above dimensions and curvatures described with reference to FIG. 2A should be construed to include a manufacturing tolerance of plus or minus 0.03125 inches. Further, each of the above dimensions may also be a selected dimension in a range of acceptable dimensions that may vary from any amount between outer limits of plus or minus 50% of the stated dimension. Thus, for example, a distance of 0.125 inches should be construed for purposes of original disclosure to mean that the dimension may be any selected value between and inclusive of 0.0625 and 0.1875 inches. Accordingly, it should be appreciated that many other configurations of the fastener caps 100 are contemplated, including those with different dimensions or curvatures, among others. In some implementations, the selection of the shape and arrangement of the edges or surfaces of the caps 100 is ornamental rather than for a functional or utilitarian purpose.

The above dimensions and curvatures are provided as a non-limiting example of a preferred implementation of a fastener cap 100 that provides sufficient structural strength and/or rigidity to allow a fastener such as a nail or screw to be inserted through the fastener cap 100 by an applicator (whether automatic, assisted, or manual) without breaking or damaging the fastener cap 100 while also preventing moisture intrusion through the fastener hole. Further, the dimensions of the fastener cap 100, and particularly of the webs 104, were selected because of their advantageous properties with respect to application of the caps 100 by an applicator such as a cap nailer or nail gun. The dimensions described above allow for the connection between the caps 100 at the webs 124 to have sufficient strength for the caps 104 to be stored and transported in a rolled configuration, while also being weak enough to allow each individual cap 100 to be reliably and consistently broken from the roll of caps 100 by the applicator during use. Further, the dimensions of the body 102 and other features beyond the webs 124 were selected to give the caps 104 sufficient strength and/or rigidity for the intended application of the caps 104 as a fastener cap for securing various types of underlayment while also enabling the caps 104 to be applied with a range of commercially available applicators (i.e., the applicators are a limiting factor on size). Changing the above dimensions of the will change the properties of the caps 100 and how effectively the caps 100 are applied to a substrate by an applicator.

FIG. 2B is a plan view of the fastener caps 100 joined together in a strip 148. Specifically, and as further described herein, the webs 124 of adjacent caps 100 are formed together as a single, integral, unitary structure during the manufacturing process. Accordingly, the webs 124 interconnect the caps 100 and allow for product of a continuous strip 148, as in FIG. 2B, that can then be rolled into a roll of selected diameter. During use, the strip 148 is fed through an applicator and the applicator applies the fastener through the caps 100. The force of the applicator in applying the fastener through the caps 100 breaks the webs 124 to remove only a single cap 100 from the strip 148 at a time. Where manual tools are used, a user can break apart the caps 100 by hand. Further, in the connected or collated state shown in FIG. 2B, the webs 124 are aligned on two separate axis through the caps 100. Each axis may be horizontal and parallel to the other axis. Further, each axis is spaced by a selected and equal distance from the horizontal centerline 106A (FIG. 2A) of the caps 100. Other configurations with different alignments of the webs 124 are also considered herein, including different spacing or arrangement as well as one, two, three or more webs 124 on each cap 100 with a selected configuration for a connection to the other webs 124.

FIG. 2C is an isometric view of collated fastener caps 100 in a roll 150. The roll 150 may have a core-less design that is indicated with reference 152. The core-less design is shown and described further with reference to FIG. 2D below. Further, the roll 150 may have an outer diameter 154 that corresponds to a number of caps 100 in the roll 150. In a preferred implementation, and as alluded to above, the roll 150 contains 400 caps 100 and the diameter is 5.25 inches. Thus, the concepts of the disclosure enable twice the number of caps 100 to be included in a roll that is the same outer diameter as conventional solutions, which provides the benefits described herein. The additional caps 100 can be included in the roll 150 because of the reduce thickness of the caps 100 and/or the core-less design 152. As will be described further below, the manufacturing process for the caps 100, the strip 148, and the roll 150 enables formation of a continuous strip of interconnected caps that may be up to 3,000 feet long and include up to 30,000 caps 100. Thus, the number of caps 100 in the roll 150 may generally be any number from a minimum of 3 to form the roll shape up to a maximum of 30,000 caps 100. The limit of 30,000 caps 100 is due to current manufacturing limitations. Advancements in manufacturing may allow for inclusion of more than 30,000 caps 100 in a single roll in the future.

FIG. 2D is a schematic view of the core-less design 152 of the roll 150. In this context only, “core-less” means a roll without any kind of separate supporting structure (i.e., plastic or carboard cylinder) at the center of a roll such that the center or core of the roll is defined only by the caps that constitute the strip 148 and/or roll 150. In other words, the core-less design 152 eliminates the core 28 and any equivalent structures that may be used with current solutions. FIG. 2D schematically illustrates that the core-less design 152 of the roll 150 is an opening 154 at a center of the roll 150 with boundaries of the opening 154 defined by three caps 100 arranged generally or substantially in the shape of a triangle. It is important to note that the core-less design 152 shown in FIG. 2D is illustrated schematically as three caps 100 joined together in a closed triangle. In practice, one of the vertices of the triangle is open to allow the other caps 100 in the roll 150 to wrap around the three center caps shown in FIG. 2D. This arrangement of the triangular-shaped opening 154 and the wrapping of the remaining caps 100 around the three central caps 100 is shown more clearly at the center of the roll 150 in FIG. 2C.

In more detail, the roll 150 is comprised of a single strip of 400 interconnected caps 100 that are rolled around each other to create the roll 150 and the core-less design 152. In the rolled configuration, outermost caps 100 of the strip of caps 148 are not adjoined to other caps 100 on both sides. Instead, the outermost caps 100 of the strip are joined to an adjoining cap 100 on only one side. In other words, because the strip 148 of caps 100 is rolled to create the core-less design 152, the outermost caps 100 in the strip 148 are not coupled to other caps 100 on one of their sides. Thus, the outermost caps 100 in the strip 148 are free on one side such that at the center of the roll, the opening 154 can be defined by three of the caps 100 and the remaining strip 148 of caps 100 can be wound around the three central caps 100. Thus, in the core-less design 152 of FIG. 2D, one of the illustrated caps 100 is the outermost cap 100 of the strip 148 that is attached to another cap 100 on only one side such that the center of the roll 150 is open at one vertex (corresponding to the outermost cap 100) and the other caps 100 wrap around the three central caps 100 that define the core-less design 152. In some implementations, the center opening 154 assists with engaging corresponding support structures in certain applicators that are inserted through the opening 154. In further implementations, the center opening 154 is the result of the folding of the three caps 100 at the center of the roll 150 and does not assist with engaging any part of the applicator.

Because the core-less design 152 is composed of an opening 154 defined by three caps 100 generally arranged in a triangle that is open on one side to allow the other caps 100 in the roll 150 to wrap around the three central caps and opening 154, the dimensions of the center of the roll 150 generally correspond to the dimensions of the caps 100. Specifically, each side of the opening 154 bounded by the caps 100 may have a length 156 or other dimension of 0.844 inches, which corresponds to the width 108 of the cap 100 described with reference to FIG. 2A. An angle 158 between the caps 104 may vary depending on the exact nature of the fold between the caps 100 to create the roll 150, but preferably, the angle 158 is equal or approximately equal at each vertex of the triangle and is approximately 60 degrees such that the core-less design 152 is an equilateral triangle. Accordingly, an area or size of the of the opening 154 may correspond to the area of an equilateral triangle (or some other triangle) with legs that are each 0.844 inches in length, thus resulting in an area of the opening of 0.30845 square inches. The length 156, the angle 158, and the area of the opening 154 may have the same tolerances and variances for the dimensions and curvatures described above with reference to FIG. 2A.

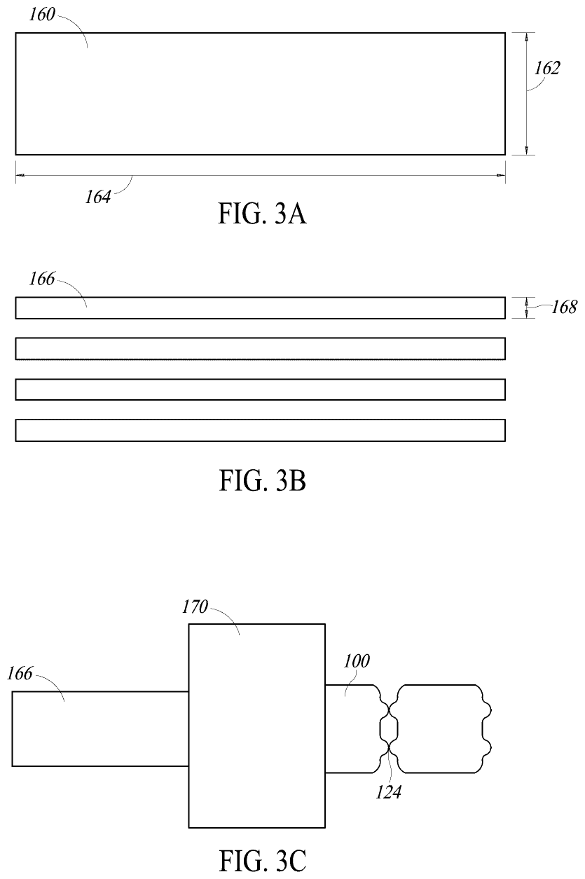

FIGS. 3A-3C are schematic views illustrating steps in a manufacturing process of the fastener cap 100, the strip 148, or the roll 150 described above. The process begins in FIG. 3A by extruding a sheet of material 160. The sheet 160 may have a width 162 of approximately 30 inches (subject to the same tolerances and variances described above with reference to FIG. 2A and may have a selected length 164 that may be less than one foot or up to 3,000 feet or some other maximum length according to current manufacturing technology. The width 162 may also be different than 30 inches depending on the manufacturing equipment used and may exceed the variances and tolerances described above with reference to FIG. 2A. The extruding process may be performed with conventional technology and techniques. Further, the sheet 160 preferably is extruded through a die with a thickness that corresponds to a desired thickness of the resulting caps 100, namely about 0.035 inches thick.

Then, in FIG. 3B, the sheet 160 is cut, slit, separated, or otherwise divided in a length direction of the sheet 160 into strips 166. Each strip 166 preferably has a width 168 that corresponds to a desired width of the resulting caps 100, which may be 0.844 inches as stated with reference to FIG. 2A. The sheet 160 may be separated into the strips 166 with assistance of a variety of available cutting machines. Thus, each sheet 30 of approximately 30 inches is divided into approximately 35 strips each with the width 168.

In FIG. 3C, the strips 166 are provided to a die cutting machine 170 that includes a cutting die having a shape that corresponds to the negative space of the strips 166 surrounding each cap 100. In other words, the cutting die has a shape that corresponds to the voids in the strip 166 that are removed to form each cap 100 such that a combination of the shape of the die and a shape of the resulting caps 100 equates to the size and shape of each strip 166. The die cutting machine 170 uses the die to cut or stamp each cap 100 from the strips 166. The die cutting process is performed continuously and results in a strip of interconnected caps 100 (such as strip 148) that are interconnected or collated as a single, unitary, integral structure via the webs 124. The die cutting process allows for formation of thinner caps 100 while also forming the interconnected caps 100 as a single, continuous structure via the webs 124. Accordingly, the strips 166 are cut at the die cutting machine 170 and output as a completed strip 148 of caps 100 that can be rolled or otherwise stored to finish the process.

Overall, this process reduces the material needed for each cap 100 because extrusion and die cutting are more effective for thinner parts with a reduced likelihood of deformation and increases the number of caps 100 per roll 150. In addition, this continuous manufacturing process is faster and more efficient than discontinuous processes such as molding each individual part and welding the parts together. All of these amount to a significant improvement in efficiency and cost of manufacturing that can be shared with consumers.

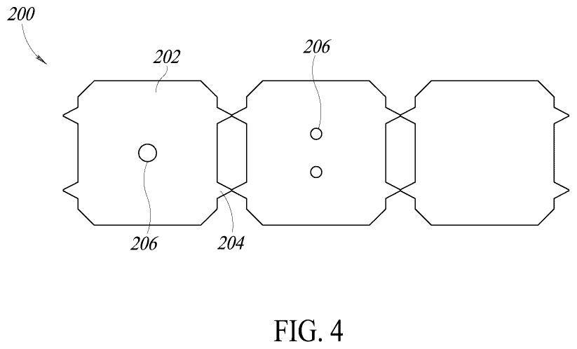

FIG. 4 is a plan view of an implementation of a strip 200 of fastener caps 202 according to the present disclosure. FIG. 4 is provided to illustrate an alternative or additional implementation of the caps 202 and to demonstrate that the disclosure is not limited to any one shape or configuration of the caps 202. In the caps 200, the protrusions and webs of the caps 100 are replaced with triangular webs 204 that meet adjacent or successive extensions 204 of other caps 202 in the strip 200 at their vertices. The extensions 204 are interconnected in a similar manner to the webs 124. Thus, instead of rounded protrusions 104 and square or rectangular webs 124, the caps 202 may instead have triangular (or some other shape) extensions or webs 204 to facilitate the connection between the caps 202. Further, the caps 200 may have a through-hole 206 at a selected location (preferably in the center) to allow for insertion of a fastener such as a nail, or a pair of holes 206 for other types of fasteners such as staples.

The present disclosure is not limited to any particular shape or configuration of the structures that connect the caps 100, 200. While square, rectangular, and/or triangular webs are shown and described, any other geometric shape is considered for the structure that facilitates the interconnection, including without limitation, trapezoidal, pentagonal, hexagonal, polygonal with a selected number of sides, circular, semicircular, ovular, kite-shaped, parallelogram or rhombus-shaped, arrow-shaped, trefoil-shaped, quatrefoil-shaped, cross-shaped, elliptical, crescent-shaped, star-shaped, hexagram-shaped, and others, whether in whole or in part. Accordingly, while preferred implementations have been shown and described, the disclosure is not limited to these preferred implementations.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the fastener cap context, and are not limited to the example systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with fastener cap devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a fastener cap may refer to one fastener cap. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, plastics, metal, polymers, thermoplastics, elastomers, plastic compounds, biodegradable materials, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims priority to U.S. Provisional Patent Application No. 63/702,042, filed Oct. 1, 2024, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A device, comprising:
a fastener cap, including:
a body having a top edge, a bottom edge, and side edges extending between the top and bottom edges, wherein the body has a thickness between 0.01 inches and 0.05 inches;
a plurality of protrusions extending from the body; and
a plurality of webs extending from the plurality of protrusions, wherein each of the plurality of webs extend from a corresponding one of the plurality of protrusions by a distance between about 0.002 and about 0.012 inches and have a width between about 0.005 and about 0.020 inches.

2. The device of claim 1, wherein the plurality of protrusions extend from the side edges of the body, or
wherein the plurality of protrusions are each in different quadrants of the body, and wherein the different quadrants of the body are defined by a horizontal centerline and a vertical centerline through the body.

3. The device of claim 1, wherein the plurality of protrusions include a pair of first protrusions extending a first side edge of the side edges of the body and a pair of second protrusions extending form a second side edge of the side edges of the body, and
wherein the pair of first protrusions are aligned with the pair of second protrusions along two spaced apart horizontal axis through the body.

4. The device of claim 1, wherein the fastener cap is a first fastener cap, the device further comprising:
a second fastener cap, including:
a body;
a plurality of protrusions extending from the body; and
a plurality of webs extending from the plurality of protrusions, wherein the plurality of webs of the second fastener cap are coupled to the plurality of webs of the first fastener cap in a single, unitary, integral structure.

5. The device of claim 1, wherein the plurality of protrusions are rounded.

6. The device of claim 1, wherein at least one of the side edges of the body includes a convex curve, a concave curve, and a vertical section, or
wherein at least one of the side edges of the body includes at least two curves each having a different radii of curvature.

7. The device of claim 1, wherein a width of the fastener cap is between about 0.6 and about 1.2 inches and a pitch of the fastener cap is between about 0.8 and about 1.2 inches, or
wherein a width of the fastener cap is less than a pitch of the fastener cap.

8. The device of claim 1, wherein each of the plurality of protrusions and each of the plurality of webs is spaced from a horizontal centerline through the body.

9. The device of claim 1, wherein the fastener cap is one of a plurality of fastener of fastener caps interconnected by the plurality of webs in a roll.

10. The device of claim 9, wherein the plurality of fastener caps includes at least 300 caps in the roll and the roll has an outer diameter of 5.25 inches, or
wherein the plurality of fastener caps includes up to 1,000 caps in the roll.

11. The device of claim 9, wherein the roll has a core-less design with an opening at the center of the roll.

12. A device, comprising:
a roll of interconnected fastener caps, wherein each fastener cap includes:
a body having a thickness between 0.01 inches and 0.05 inches;
a plurality of protrusions extending from the body; and
a plurality of webs extending from the plurality of protrusions and coupled to adjoining webs of a successive one of the interconnected faster caps,
wherein the roll has an outer diameter between 5 and 6 inches, and
wherein the roll includes at least 300 interconnected fastener caps.

13. The device of claim 12, wherein the roll includes up to 1,000 interconnected fastener caps.

14. The device of claim 12, wherein each of the plurality of protrusions are rounded and each of the plurality of webs extend from a corresponding one of the plurality of protrusions by a distance between about 0.002 and about 0.012 inches and have a width between about 0.005 and about 0.020 inches.

15. The device of claim 12, wherein the roll has a core-less design with an opening at the center of the roll.

16. The device of claim 15, wherein a width of each fastener cap is between about 0.6 and about 1.2 inches and a pitch of each fastener cap is between about 0.8 and about 1.2 inches.

17.-20. (canceled)

21. A device, comprising:
a fastener cap, including:
a body having a flat top surface, a flat bottom surface, a thickness between the flat top surface and the flat bottom surface, and sidewalls extending between the flat top surface and the flat bottom surface, wherein the thickness is constant and the sidewalls are perpendicular to the flat top surface and the flat bottom surface;
a plurality of protrusions extending from the body; and
a plurality of webs extending from the plurality of protrusions.

22. The device of claim 21, wherein the device is formed by the process of die cutting.

23. The device of claim 21, wherein the thickness is constant across an entire width of the body.

24. The device of claim 21, wherein the plurality of protrusions have a thickness that is the same as the thickness of the body.
